(19) United States
(12) Patent Application Publication
(10) Pub. No.: US 2026/0257554 A1
(43) Pub. Date: Sep. 3, 2026

(54) DISPLAY CONTROL METHOD AND DISPLAY CONTROL APPARATUS, VEHICLE-MOUNTED DISPLAY SYSTEM AND STORAGE MEDIA

(71) Applicant: BOE TECHNOLOGY GROUP CO., LTD., Beijing (CN)

(72) Inventors: Xitong MA, Beijing (CN); Hua HUANG, Beijing (CN); Lihua GENG, Beijing (CN); Youxiang XIA, Beijing (CN)

(73) Assignee: BOE TECHNOLOGY GROUP CO., LTD., Beijing (CN)

(21) Appl. No.: 18/994,813

(22) PCT Filed: Aug. 31, 2023
(86) PCT No.: PCT/CN2023/116157

§ 371 Date: Jan. 15, 2025

(51) Int. Cl. B60K 35/22; G06T 1/60; G06T 5/50; G06T 7/11

(52) U.S. Cl. CPC B60K 35/22; G06T 1/60; G06T 5/50; G06T 7/11; G06T 2207/20221

(57) ABSTRACT

The present disclosure provides a display control method and a display control apparatus, a vehicle-mounted display system, and a storage medium. The display control method includes: dividing a video frame received in a current frame period into m subframes, wherein the m subframes are in one-to-one correspondence with m display areas on a display device; selecting a subframe from the m subframes as a target subframe; writing m-1 subframes other than the target subframe among the m subframes to a buffer; reading m-1 subframes located between the target subframe of the current frame period and a target subframe of a previous frame period from the buffer according to a timing of each of the m subframes; generating a display frame based on the target subframe of the current frame period and the m-1 subframes read from the buffer; and sending the display frame to the display device for display.

### CROSS-REFERENCE TO RELATED APPLICATIONS

The present application is a U.S. National Stage Application under 35 U.S.C. § 371 of International Patent Application No. PCT/CN2023/116157, filed on Aug. 31, 2023, the disclosure of which is incorporated by reference herein in its entirety.

### TECHNICAL FIELD

This disclosure relates to the technical field of display, particularly to a display control method and a display control apparatus, a vehicle-mounted display system, and a storage medium.

### BACKGROUND

A vehicle-mounted display device can perform partitioned display. For example, a vehicle-mounted display device can be partitioned into multiple display areas, such as an instrument area, a navigation area, and an entertainment area. Each video frame provided by a SOC (System on Chip) contains multiple parts that one-to-one correspondence with the multiple display areas. By displaying such a video frame on the vehicle-mounted display device, corresponding content can be displayed in each display area.

### SUMMARY

According to a first aspect of the embodiments of the present disclosure, there is provided a display control method, comprising: dividing a video frame received in a current frame period into m subframes, wherein the m subframes are in one-to-one correspondence with m display areas on a display device, m being a natural number greater than 1; selecting a subframe from the m subframes as a target subframe according to a preset rule; writing m−1 subframes other than the target subframe among the m subframes to a buffer; reading m−1 subframes located between the target subframe of the current frame period and a target subframe of a previous frame period from the buffer according to a timing of each of the m subframes; generating a display frame based on the target subframe of the current frame period and the m−1 subframes read from the buffer; and sending the display frame to the display device for display.

In some embodiments, the buffer comprises m−1 subbuffers that are in one-to-one correspondence with the m−1 subframes, wherein the writing the m−1 subframes to the buffer comprises: writing each of the m−1 subframes to a subbuffer corresponding to a current write address, wherein the current write address is determined from the current frame period.

In some embodiments, the reading the m−1 subframes from the buffer comprises: reading the m−1 subframes of the current frame period from the buffer in a case where the target subframe of the current frame period is a subframe with a latest timing of the current frame period.

In some embodiments, the reading the m−1 subframes of the current frame period from the buffer comprises: reading a subframe from each of the m−1 subbuffers according to a current read address, wherein the current read address is identical to the current write address.

In some embodiments, the generating the display frame comprises: combining the m−1 subframes of the current frame period and the target subframe of the current frame period to generate the display frame.

In some embodiments, the reading the m−1 subframes from the buffer comprises: reading last m−1 subframes in timing of the previous frame period from the buffer in a case where the target subframe of the current frame period is a subframe with an earliest timing of the current frame period.

In some embodiments, the reading the m−1 subframes of the previous frame period from the buffer comprises: reading a subframe from each of the m−1 subbuffers according to the current read address, wherein the current read address is the current write address subtracted by 1.

In some embodiments, the generating the display frame comprises: combining the target subframe of the current frame period and the last m−1 subframes in timing of the previous frame period to generate the display frame.

In some embodiments, the reading the m−1 subframes from the buffer comprises: reading k subframes of the current frame period from the buffer and reading last m−k−1 subframes in timing of the previous frame period from the buffer in a case where timings of the k subframes of the current frame period are earlier than a timing of the target subframe of the current frame period, wherein 1≤k<m−1.

In some embodiments, the reading the k subframes from the buffer comprises: reading the k subframes from k subbuffers corresponding to the k subframes among the m−1 subbuffers according to a first read address, wherein the first read address is identical to the current write address; and the reading the m−k−1 subframes from the buffer comprises: reading the m−k−1 subframes from m−k−1 subbuffers corresponding to the m−k−1 subframes among the m−1 subbuffers according to a second read address, wherein the second read address is the current write address subtracted by 1.

In some embodiments, the generating the display frame comprises: combining the k subframes of the current frame period, the target subframe of the current frame period and the m−k−1 subframes of the previous frame period to generate the display frame.

In some embodiments, the target subframe is a subframe with a maximum delay weight among the m subframes.

In some embodiments, the target subframe is a subframe specified by a received instruction among the m subframes.

In some embodiments, wherein the sending the display frame to the display device comprises: dividing the display frame into a first display subframe and a second display subframe; sending the first display subframe to the display device through a first display interface; sending the second display subframe to the display device through a second display interface.

According to a second aspect of the embodiments of the present disclosure, there is provided a display control apparatus, comprising: a processor; and a memory coupled to the processor, storing program instructions which, when executed by the processor, cause the processor to execute the display control method according to any one of the above embodiments.

According to a third aspect of the embodiments of the present disclosure, there is provided a display control apparatus, comprising: a receiving circuit configured to receive a video frame of a current frame period; a dividing circuit configured to divide the video frame of the current frame period into m subframes, wherein the m subframes are in one-to-one correspondence with m display areas on a display device, m being a natural number greater than 1; a selecting circuit configured to select a subframe from the m subframes as a target subframe according to a preset rule, send the target subframe among the m subframes to a reordering circuit, and write m−1 subframes other than the target subframe among the m subframes to a buffer by a write control circuit; the reordering circuit configured to read m−1 subframes located between the target subframe of the current frame period and a target subframe of a previous frame period from the buffer by a read control circuit according to a timing of each of the m subframes, and generate a display frame based on the target subframe of the current frame period and the m−1 subframes read from the buffer; and a sending circuit configured to send the display frame to the display device for display.

In some embodiments, the buffer comprises m−1 subbuffers that are in one-to-one correspondence with the m−1 subframes, wherein the write control circuit is configured to write each of the m−1 subframes to a subbuffer corresponding to a current write address, wherein the current write address is determined from the current: frame period.

In some embodiments, the reordering circuit is configured to read the m−1 subframes of the current frame period from the buffer by the read control circuit in a case where the target subframe of the current frame period is a subframe with a latest timing of the current frame period.

In some embodiments, the read control circuit is configured to read a subframe from each of the m−1 subbuffers according to a current read address, wherein the current read address is identical to the current write address.

In some embodiments, the reordering circuit is configured to combine the m−1 subframes of the current frame period and the target subframe of the current frame period to generate the display frame.

In some embodiments, the reordering circuit is configured to read last m−1 subframes in timing of the previous frame period from the buffer by the read control circuit in a case where the target subframe of the current frame period is a subframe with an earliest timing of the current frame period.

In some embodiments, the read control circuit is configured to read a subframe from each of the m−1 subbuffers according to the current read address, wherein the current read address is the current write address subtracted by 1.

In some embodiments, the reordering circuit is configured to combine the target subframe of the current frame period and the last m−1 subframes in timing of the previous frame period to generate the display frame.

In some embodiments, the reordering circuit is configured to read k subframes of the current frame period from the buffer and read last m−k−1 subframes in timing of the previous frame period from the buffer by the read control circuit in a case where timings of the k subframes of the current frame period are earlier than a timing of the target subframe of the current frame period, wherein 1≤k<m−1.

In some embodiments, the read control circuit is configured to read the k subframes from k subbuffers corresponding to the k subframes among the m−1 subbuffers according to a first read address, wherein the first read address is identical to the current write address, and read the m−k−1 subframes from m−k−1 subbuffers corresponding to the m−k−1 subframes among the m−1 subbuffers according to a second read address, wherein the second read address is the current write address subtracted by 1.

In some embodiments, the reordering circuit is configured to combine the k subframes of the current frame period, the target subframe of the current frame period and the m−k−1 subframes of the previous frame period to generate the display frame. According to a fourth aspect of the embodiments of the present disclosure, there is provided a vehicle-mounted display system, comprising: a display control apparatus according to any one of the above embodiments; a display device configured to receive a display frame sent by the display control apparatus and present the display frame.

According to a fifth aspect of the embodiments of the present disclosure, there is provided a non-transitory computer-readable storage medium stored thereon computer instructions that, when executed by a processor, implement the method according to any one of the above embodiments.

Other features and advantages of the present invention will become apparent from following detailed description of exemplary embodiments of the present disclosure with reference to the accompanying drawings.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 is a flowchart of a display control method according to one embodiment of the present disclosure;

FIGS. 2A to 2C are schematic diagrams of timing sequences of subframes according to some embodiments of the present disclosure;

FIG. 3 is a schematic diagram of a process of reading subframes according to one embodiment of the present disclosure;

FIG. 4 is a schematic diagram of a process of reading subframes according to another embodiment of the present disclosure;

FIG. 5 is a schematic diagram of a process of reading subframes according to still another embodiment of the present disclosure;

FIG. 6 is a schematic diagram of a framing process according to one embodiment of the present disclosure;

FIG. 7 is a schematic diagram of a framing process according to another embodiment of the present disclosure;

FIG. 8 is a schematic diagram of a framing process according to still another embodiment of the present disclosure;

FIG. 9 is a schematic diagram of a process of dividing display frame according to an embodiment of the present disclosure;

FIG. 10 is a structural diagram of a display control apparatus according to one embodiment of the present disclosure;

FIG. 11 is a structural diagram of a display control apparatus according to another embodiment of the present disclosure;

FIG. 12 is a structural diagram of a vehicle-mounted display system according to one embodiment of the present disclosure.

It should be understood that the dimensions of the various parts shown in the drawings are not drawn to the actual scale. In addition, the same or similar reference signs are used to denote the same or similar components.

### DETAILED DESCRIPTION

Various exemplary embodiments of the present disclosure will now be described in detail with reference to the accompanying drawings. The following description of the exemplary embodiments is in fact merely illustrative and is in no way intended as a limitation to the present disclosure, its application or use. The present disclosure may be implemented in many different forms, not limited to the embodiments described herein. These embodiments are provided so that this disclosure will be thorough and complete, and will fully convey the scope of the disclosure to those skilled in the art. Notice that, unless specifically stated otherwise, relative arrangement of components and steps, material composition, numerical expressions, and numerical values set forth in these embodiments are to be construed as merely illustrative, and not as a limitation.

The use of the terms “first”, “second” or the like in the present disclosure does not denote any order, quantity or importance, but are merely used to distinguish between different components. A word such as “includes” or “comprises” means that the element before the word covers the elements listed after the word, without excluding the possibility of also covering other elements.

Unless otherwise defined, all terms (including technical and scientific terms) used herein have the same meaning as commonly understood by one of ordinary skill in the art to which exemplary embodiments in accordance with principles of inventive concepts belong. It will also be understood that terms defined in such general-purpose dictionaries should be interpreted as having a meaning that is consistent with their meaning in the context of the relevant art, and not to be interpreted in an idealized or overly formal sense, unless explicitly defined herein.

Techniques, methods, and apparatus known to those of ordinary skill in the relevant art may not be discussed in detail, but where appropriate, these techniques, methods, and apparatuses should be considered as part of the specification.

The inventors noticed that in a case where a vehicle-mounted display device can perform partitioned display, when a user performs touch operation on a display area of the vehicle-mounted display device, it is desirable that the display delay of the display area can be reduced. Because a same control method is currently used for the content displayed in different display areas, it is not possible to effectively reduce the display delay of a specified display area.

Accordingly, the present disclosure provides a display control scheme that can effectively reduce the display delay of the specified display area and improve the user experience by employing different control methods for subframes displayed in different display areas.

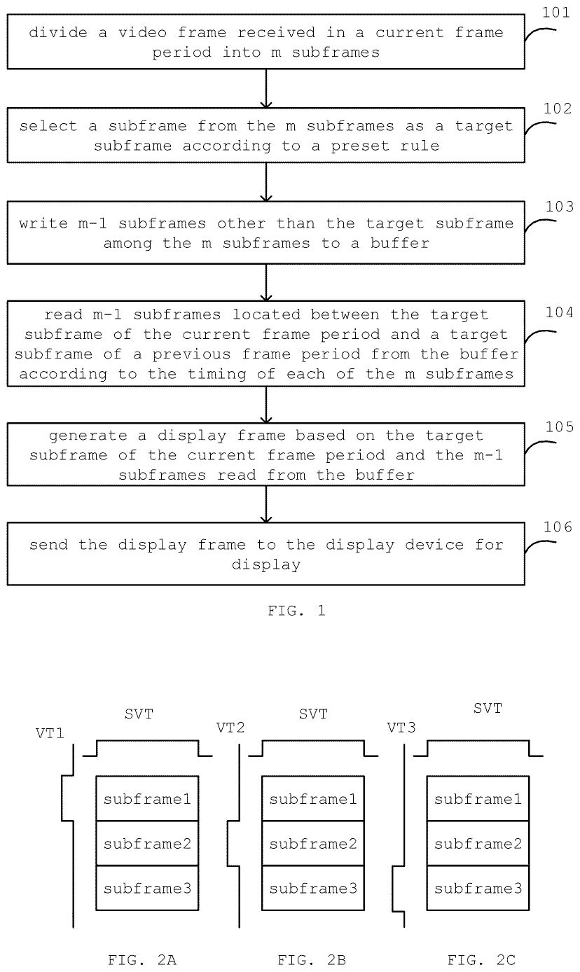

FIG. 1 is a flowchart of a display control method according to one embodiment of the present disclosure. In some embodiments, the display control method is performed by a display control apparatus.

In step 101, a video frame received in a current frame period is divided into m subframes, wherein the m subframes are in one-to-one correspondence with m display areas on a display device, m being a natural number greater than 1.

It should be noted that in order to facilitate the control of the display content of each display area on the display device, frame period is divided. For the video frame of the current example, if the display device includes three display areas, the video frame of the current frame period is divided into three subframes, wherein a first subframe is used to display in a first display area, a second subframe is used to display in a second display area, and a third subframe is used to display in a third display area.

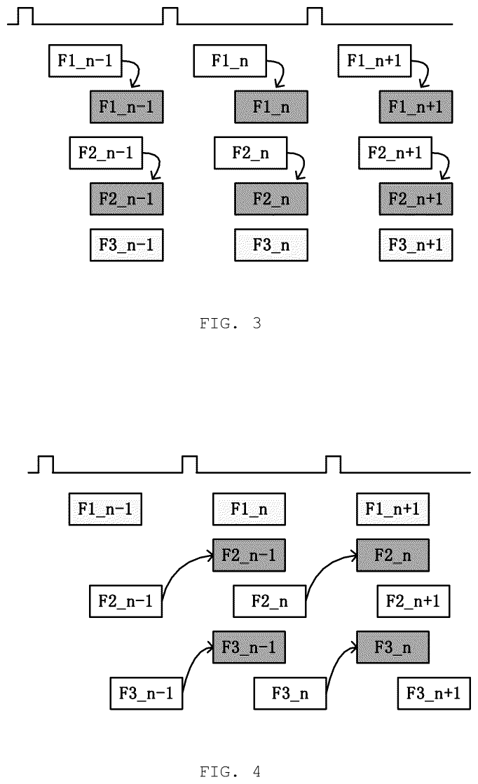

To facilitate the processing of the m subframes, a different timing is configured for each of the m subframes. For example, in a case where the video frame is divided into 3 subframes, in a frame period SVT, a first timing VT1 is configured for the first subframe as shown in FIG. 2A, a second timing VT2 is configured for the second subframe as shown in FIG. 2B, and a third timing VT3 is configured for the third subframe as shown in FIG. 2C.

In step 102, a subframe is selected from the m subframes as a target subframe according to a preset rule.

In some embodiments, the target subframe is a subframe specified by a received instruction among the m subframes. For example, in a case where the video frame is divided into three subframes, the received instruction indicates that the user has performed a touch operation on the second display area, a second subframe corresponding to the second display area is used as the target subframe. In this case, the first subframe and third subframe are written to the buffer instead of writing the second subframe to the buffer.

In some embodiments, the target subframe is a subframe with a maximum delay weight among the m subframes. For example, in a case where the video frame is divided into three subframes and the second subframe has a preset maximum delay weight, the second subframe is used as the target subframe. In this case, the first and third subframes are written to the buffer instead of writing the second subframe to the buffer.

That is to say, in a case where the user does not perform the touch operation on the vehicle-mounted display device, a target subframe can be selected based on the preset delay weight for subframe corresponding to the each of display areas.

In step 103, m−1 subframes other than the target subframe among the m subframes are written to a buffer.

It should be noted that only the m−1 subframes other than the target subframe among the m subframes are written to the buffer, and the target subframe is not written to the buffer, thereby effectively reducing the delay of the target subframe.

In some embodiments, the buffer comprises m−1 subbuffers that are in one-to-one correspondence with the m−1 subframes. In this case, each of the m−1 subframes is written to a subbuffer corresponding to a current write address WDMA_{-addr}, wherein the current write address WDMA_{-addr} is determined from the current frame period.

For example, each subbuffer has a ring memory structure and the initial value of the write address is 0, i.e. WDMA_{-addr}=0. In a case where a rising edge of a frame sync signal is detected in the current frame period, the write address is updated by an increment of 1. At this time, the updated write address is WDMA_{-addr}=1, and so on. If there are n memory space in the ring memory, the write address WDMA_{-addr}=n and the write address WDMA_{-addr}=0 correspond to the same memory space, such that cyclic storage can be achieved by the above processing.

For example, in a case where a video frame is divided into 3 subframes and the second subframe is the target subframe, the first subframe is written to a first subframe buffer and the third subframe is written to a second subframe buffer based on the current write address.

In step 104, m−1 subframes located between the target subframe of the current frame period and a target subframe of a previous frame period are read from the buffer according to the timing of each of the m subframes.

In some embodiments, m−1 subframes of the current frame period are read from the buffer in a case where the target subframe of the current frame period is the subframe with the latest timing of the current frame period.

In this case, the current read address is identical to the current write address, i.e., RDMA_{-addr}=WDMA_{-addr}. According to the current read address, a subframe is read from each of the m−1 subbuffers.

For example, as shown in FIG. 3, there are 3 subframes in each frame period. A subframe F1_n, a subframe F2_n, and a subframe F3_n are included in the n^{th} frame period, and the subframe F3_n is the target subframe. Since the subframe F3_n is the subframe with the lasted timing of the n^{th} frame period, subframes F1_n and F2_n of the n^{th} frame period, represented by dark boxes, are read from the buffer based on the timing trigger of the subframe F3_n.

Based on the same processing method, as shown in FIG. 3, in the (n−1)th frame period, subframes F1_n−1 and F2_n−1 of the (n−1)th frame period are read from the buffer based on the timing trigger of the target subframe F3_n−1. In the (n+1)th frame period, subframes F1_n+1 and F2_n+1 of the (n+1)th frame period, represented by dark boxes, are read from the buffer based on the timing trigger of target subframe F3_n+1.

In some embodiments, the last m−1 subframes in timing of the previous frame period are read from the buffer in a case where the target subframe of the current frame period is the subframe with the earliest timing of the current frame period.

In this case, RDMA__{addr}=WDMA__{addr}−1, i.e., the current read address is the current write address subtracted by 1. According to the current read address, a subframe is read from each of the m−1 subbuffers.

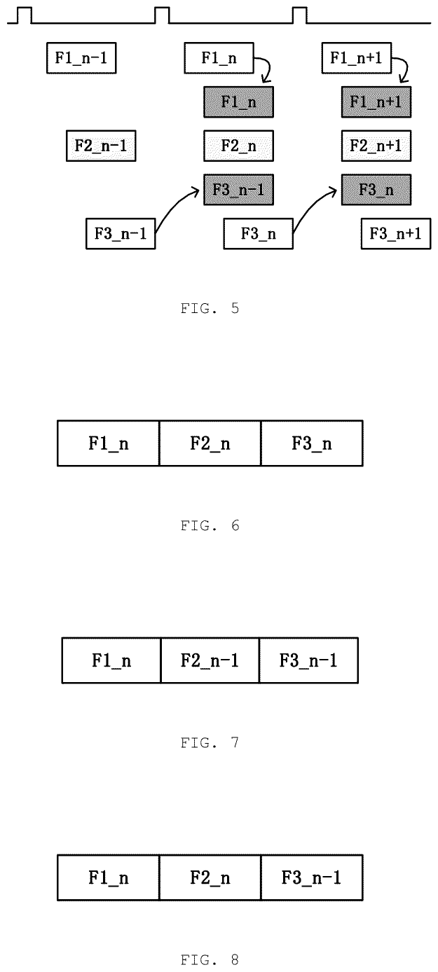

For example, as shown in FIG. 4, there are 3 subframes in each frame period. A subframe F1_n, a subframe F2_n, and a subframe F3_n are included in the n^{th} frame period, and the subframe F1_n is the target subframe. Since the subframe F1_n is the subframe with the earliest timing of the n^{th} frame period, subframes F2_n−1 and F3_n−1 of the (n−1)th frame period, represented by dark boxes, are read from the buffer based on the timing trigger of the subframe F1_n.

Based on the same processing method, as shown in FIG. 4, in the (n+1)th frame period, subframes F2_n and F3_n of the nth frame period, represented by dark boxes, are read from the buffer based on the timing trigger of the target subframe F1_n+1.

In some embodiments, in a case where timings of the k subframes of the current frame period are earlier than a timing of the target subframe of the current frame period, the k subframes of the current frame period are read from the buffer, and last m−k−1 subframes in timing of the previous frame period are read from the buffer, wherein 1≤k<m−1.

In this case, the k subframes of the current frame period are read from k subbuffers corresponding to the k subframes among the m−1 subbuffers according to a first read address, wherein the first read address is identical to the current write address. The last m−k−1 subframes in timing of the previous frame period are read from m−k−1 subbuffers corresponding to the m−k−1 subframes among the m−1 subbuffers according to a second read address, wherein the second read address is the current write address subtracted by 1.

For example, as shown in FIG. 5, there are 3 subframes in each frame period. A subframe F1_n, a subframe F2_n, and a subframe F3_n are included in the n^{th} frame period, and the subframe F2_n is the target subframe. In the n^{th} frame period, the timing of the subframe F2_n is later than the timing of the subframe F1_n, and the timing of the subframe F2_n is earlier than the timing of the subframe F3_n, therefore the subframe F1_n of the n^{th} frame period and the subframe F3_n−1 of the (n−1)th frame period, represented by dark boxes, are read from the buffer based on the timing trigger of the subframe F2_n.

Based on the same processing method, as shown in FIG. 5, in the (n+1)th frame period, the subframe F1_n+1 of the (n+1)th frame period and the subframe F3_n of the n^{th} frame period, represented by dark boxes, are read from the buffer based on the timing trigger of the target subframe F2_n+1.

In step 105, a display frame is generated based on the target subframe of the current frame period and the m−1 subframes read from the buffer.

In some embodiments, the m−1 subframes of the current frame period are read from the buffer in a case where the target subframe of the current frame period is the subframe with the latest timing of the current frame period.

In this case, the m−1 subframes of the current frame period and the target subframe of the current frame period are combined to generate the display frame.

For example, as shown in FIG. 3, in the n^{th} frame period, subframes F1_n and F2_n of the n^{th} frame period are read from the buffer based on the timing trigger of the target subframe F3_n, and then the subframes F1_n and F2_n read from the buffer and the target subframe F3_n are combined to generate a display frame, as shown in FIG. 6.

Based on the same processing method, as shown in FIG. 3, in the (n−1)th frame period, subframes F1_n−1 and F2_n−1 of the (n−1)th frame period are read from the buffer based on the timing trigger of the target subframe F3_n−1, and the subframes F1_n−1 and F2_n−1 read from the buffer and the target subframe F3_n−1 are combined to generate a display frame. In the (n+1)th frame period, subframes F1_n+1 and F2_n+1 of the (n+1)th frame period are read from the buffer based on the timing trigger of the target subframe F3_n+1, and then the subframes F1_n+1 and F2_n+1 read from the buffer and the target subframe F3_n+1 are combined to generate a display frame.

In some embodiments, the last m−1 subframes in timing of the previous frame period are read from the buffer in a case where the target subframe of the current frame period is the subframe with the earliest timing of the current frame period.

In this case, the target subframe of the current frame period and the last m−1 subframes in timing of the previous frame period are combined to generate the display frame.

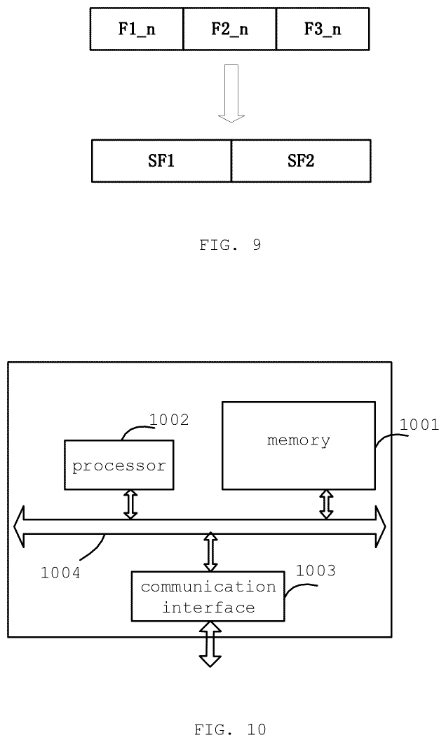

For example, as shown in FIG. 4, in the n^{th} frame period, subframes F2_n−1 and F3_n−1 of the (n−1)th frame period are read from the buffer based on the timing trigger of the target subframe F1_n, and then the target subframe F1_n and the subframes F2_n−1 and F3_n−1 read from the buffer are combined to generate a display frame, as shown in FIG. 7.

Based on the same processing method, as shown in FIG. 4, in the (n+1)th frame period, subframes F2_n and F3_n of the nth frame period are read from the buffer based on the timing trigger of the target subframe F1_n+1, and the target subframe F1_n+1 and the subframes F2_n and F3_n read from the buffer are combined to generate a display frame.

In some embodiments, in a case where timings of the k subframes of the current frame period are earlier than a timing of the target subframe of the current frame period, the k subframes of the current frame period are read from the buffer, and last m−k−1 subframes in timing of the previous frame period are read from the buffer, wherein 1≤k<m−1.

In this case, the k subframes of the current frame period and the target subframe of the current frame period and the m−k−1 subframes of the previous frame period are combined to generate the display frame.

For example, as shown in FIG. 5, in the n^{th} frame period, the subframe F1_n of the n^{th} frame period and the subframe F3_n−1 of the (n−1)th frame period are read from the buffer based on the timing trigger of the target subframe F2_n, and then the subframe F1_n read from the buffer, the target subframe F2_n, and the subframe F3_n−1 read from the buffer are combined to generate a display frame, as shown in FIG. 8.

Based on the same processing method, as shown in FIG. 5, in the (n+1)th frame period, the subframe F1_n+1 of the (n+1)th frame period and the subframe F3_n of the n^{th} frame period are read from the buffer based on the timing trigger of the target subframe F2_n+1, and the subframe F1_n+1 read from the buffer, the target subframe F2_n+1, and the subframe F3_n read from the buffer are combined to generate a display frame.

In step 106, the display frame is sent to the display device for display.

In some embodiments, the display frame is divided into a first display subframe and a second display subframe. Then, the first display subframe is sent to the display device through a first display interface, and the second display subframe is sent to the display device through a second display interface.

For example, as shown in FIG. 9, the display frame shown in FIG. 6 is divided into two display subframes, wherein the subframe F2_n is divided into a subframe F2_n-a and a subframe F2_n-b. The subframe F1_n and the subframe F2_n-a are combined to form a first display subframe SF1, and the subframe F2_n-b and the subframe F3_n are combined to form a second display subframe SF2.

For example, in the display frame shown in FIG. 6, the resolution of each subframe is 3498×1040, while the resolution of the display frame shown in FIG. 6 is 10496×1040. The resolution of the first display subframe SF1 and the second display subframe SF2 shown in FIG. 9 is 5248×1040.

In some embodiments, the first display interface and the second display interface are EDPs (Embedded Display Port).

In the display control method provided in the above embodiment of the present disclosure, the display delay of a specified display area can be effectively reduced and the user experience can be improved by employing different control methods for subframes displayed in different display areas.

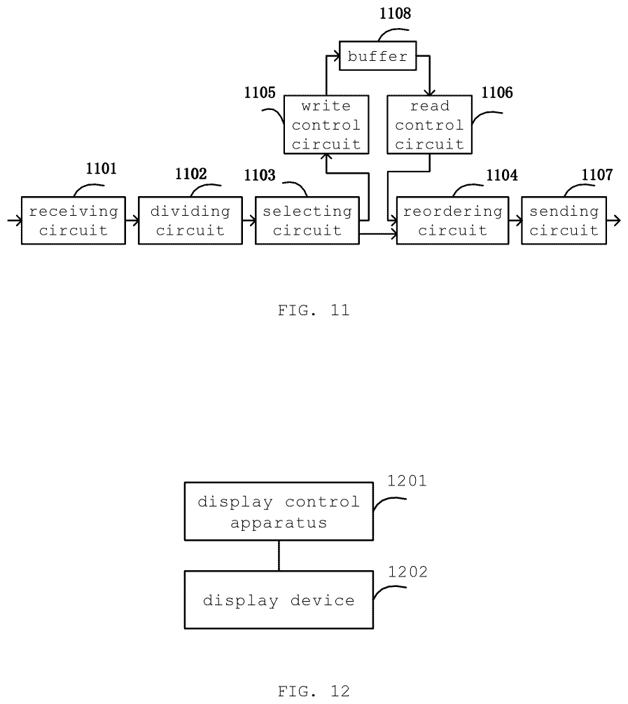

FIG. 10 is a structural diagram of a display control apparatus according to an embodiment of the present disclosure. As shown in FIG. 10, the display control apparatus comprises a memory 1001 and a processor 1002.

The memory 1001 is used for storing instructions. The processor 1002 is coupled to the memory 1001. The processor 1002 is configured to, based on instructions stored in the memory, carry out a method involved in the embodiment shown in FIG. 1.

As shown in FIG. 10, the display control apparatus further comprises a communication interface 1003 for performing information interaction with other devices. In addition, the display control apparatus further comprises a bus 1004. The processor 1002, the communication interface 1003, and the memory 1001 perform communication with each other through the bus 1004.

The memory 1001 may include high-speed RAM (Random Access Memory) or NVM (Non-Volatile Memory). For example, it may be at least one disk storage. The memory 1001 may also be a memory array. The memory 1001 may also be partitioned into blocks, which may be combined into virtual volumes according to a certain rule.

In addition, the processor 1002 may be a central processing unit (CPU), or may be an Application Specific Integrated Circuit (ASIC) or one or more integrated circuits configured to implement the embodiments of the present disclosure.

The present application further provides a non-transitory computer readable medium stored thereon computer instructions that, when executed by a processor, implement a method involved in the embodiment of FIG. 1.

FIG. 11 is a structural diagram of a display control apparatus according to another embodiment of the present disclosure. As shown in FIG. 11, the display control apparatus comprises a receiving circuit 1101, a dividing circuit 1102, a selecting circuit 1103, a reordering circuit 1104, a write control circuit 1105, a read control circuit 1106, a sending circuit 1107, and a buffer 1108.

The receiving circuit 1101 is configured to receive a video frame of a current frame period.

The dividing circuit 1102 is configured to divide the video frame of the current frame period into m subframes, wherein the m subframes are in one-to-one correspondence with m display areas on a display device, m being a natural number greater than 1.

It should be noted that in order to facilitate the control of the display content of each display area on the display device, the video frame of the current frame period is divided. For example, the display device includes three display areas, the video frame of the current frame period is divided into three subframes, wherein a first subframe is used for display in a first display area, a second subframe is used for display in a second display area, and a third subframe is used for display in a third display area.

To facilitate the processing of the obtained m subframes, a different timing is configured for each of the m subframes. For example, in a case where the video frame is divided into three subframes, in a frame period SVT, a first timing VT1 is configured for the first subframe as shown in FIG. 2A, a second timing VT2 is configured for the second subframe as shown in FIG. 2B, and a third timing VT3 is configured for the third subframe as shown in FIG. 2C.

The selecting circuit 1103 is configured to select a subframe from the m subframes as a target subframe according to a preset rule, send the target subframe among the m subframes to a reordering circuit 1104, and write m−1 subframes other than the target subframe among the m subframes to a buffer 1108 by a write control circuit 1105.

It should be noted that among the m subframes, only the m−1 subframes other than the target subframe are written to the buffer, and the target subframe is not written to the buffer, thereby effectively reducing the delay of the target subframe.

In some embodiments, the target subframe is a subframe specified by a received instruction among the m subframes. For example, in a case where the video frame is divided into three subframes, the received instruction indicates that the user has performed a touch operation on the second display area, a second subframe corresponding to the second display area is used as the target subframe. In this case, the first subframe and third subframe are written to the buffer instead of writing the second subframe to the buffer.

In some embodiments, the target subframe is a subframe with a maximum delay weight among the m subframes. For example, in a case where the video frame is divided into three subframes and the second subframe has a maximum predetermined delay weight, the second subframe is used as the target subframe. In this case, the first and third subframes are written to the buffer instead of writing the second subframe to the buffer.

That is to say, in a case where the user does not perform the touch operation on the vehicle-mounted display device, a target subframe can be selected based on the preset delay weight for subframe corresponding to the each of display areas.

In some embodiments, the buffer comprises m−1 subbuffers that are in one-to-one correspondence with the m−1 subframes. In this event, each of the m−1 subframes is written to a subbuffer corresponding to a current write address WDMA_{-addr}, wherein the current write address WDMA_{-addr} is determined from the current frame period.

The reordering circuit 1104 is configured to read the target subframe of a previous frame period and the m−1 subframes located between the target subframe of the current frame period from the buffer 1108 by a read control circuit 1106 according to a timing of each of the m subframes, and generate a display frame based on the target subframe of the current frame period and the m−1 subframes read from the buffer.

In some embodiments, the reordering circuit 1104 is configured to read the m−1 subframes of the current frame period from the buffer 1108 through the read control circuit 1006 in a case where the target subframe of the current frame period is the subframe with the latest timing of the current frame period.

For example, the read control circuit 1006 is configured to read a subframe from each of the m−1 subbuffers according to a current read address, wherein the current read address is identical to the current write address.

In this case, the reordering circuit 1104 combines the target subframe of the current frame period and the last m−1 subframes in timing of the previous frame period to generate the display frame.

For example, the subframe reading process in this scenario is shown in FIG. 3, and the generated display frame is shown in FIG. 6.

In some embodiments, the reordering circuit 1104 is configured to read the last m−1 subframes in timing of the previous frame period from the buffer in a case where the target subframe of the current frame period is the subframe with the earliest timing of the current frame period.

In some embodiments, the read control circuit 1106 is configured to read a subframe from each of the m−1 subbuffers according to the current read address, wherein the current read address is the current write address subtracted by 1.

In this case, the reordering circuit 1104 combines the target subframe of the current frame period and the last m−1 subframes in timing of the previous frame period to generate the display frame.

For example, the subframe reading process in this scenario is shown in FIG. 4, and the generated display frame is shown in FIG. 7.

In some embodiments, the reordering circuit 1104 is configured to read k subframes of the current frame period from the buffer and read last m−k−1 subframes in timing of the previous frame period from the buffer by the read control circuit 1106 in a case where timings of the k subframes of the current frame period are earlier than a timing of the target subframe of the current frame period, wherein 1≤k<m−1.

In some embodiments, the read control circuit 1106 is configured to read the k subframes from k subbuffers corresponding to the k subframes among the m−1 subbuffers according to a first read address, wherein the first read address is identical to the current write address, and further configured to read the m−k−1 subframes from m−k−1 subbuffers corresponding to the m−k−1 subframes among the m−1 subbuffers according to a second read address, wherein the second read address is the current write address subtracted by 1.

In this case, the reordering circuit 1104 combines the k subframes of the current frame period, the target subframe of the current frame period, and the m−k−1 subframes of the previous frame period to generate the display frame.

For example, the subframe reading process in this scenario is shown in FIG. 5, and the generated display frame is shown in FIG. 8.

The sending circuit 1107 is configured to send the display frame to the display device for display.

In some embodiments, the sending circuit 1107 divides the display frame into a first display subframe and a second display subframe. Then, the first display subframe is sent to the display device through a first display interface, and the second display subframe is sent to the display device through a second display interface.

For example, as shown in FIG. 9, the sending circuit 1107 divides the display frame shown in FIG. 6 into two display subframes, wherein the subframe F2_n is divided into a subframe F2_n-a and a subframe F2_n-b. The subframe F1_n and the subframe F2_n-a are combined to form a first display subframe, and the subframe F2_n-b and the subframe F3_n are combined to form a second display subframe.

For example, in the display frame shown in FIG. 6, the resolution of each subframe is 3498×1040, while the resolution of the display frame shown in FIG. 6 is 10496×1040. The resolution of the first display subframe SF1 and the second display subframe SF2 shown in FIG. 9 is 5248×1040.

In some embodiments, the first display interface and the second display interface are EDPs (Embedded Display Port).

FIG. 12 is a structural diagram of a vehicle-mounted display system according to one embodiment of the present disclosure. As shown in FIG. 12, the vehicle-mounted display system comprises a display control apparatus 1201 and a display device 1202. The display control apparatus 1201 may be a display control apparatus according to any one of the embodiments shown in FIGS. 10 and 11.

The display device 1202 is configured to receive the display frame sent by the display control apparatus 1201 and present the display frame. For example, the display device may be any product or component that has a display function such as a mobile phone, a tablet computer, a television, a monitor, a notebook computer, a digital photo frame, a navigator, and the like.

In some embodiments, the display device 1202 receives a first display subframe sent by the display control apparatus 1201 though a first display interface, a second display subframe sent by the display control apparatus 1201 through a second display interface, and concatenates the first and second display subframes for display.

For example, the resolution of the first and second display subframes is 5248×1040. By concatenating the first and second display subframes, a display frame with a resolution of 10496×1040 is obtained.

In some embodiments, the first display interface and the second display interface are EDPs.

Heretofore, various embodiments of the present disclosure have been described in detail. In order to avoid obscuring the concepts of the present disclosure, some details known in the art are not described. Based on the above description, those skilled in the art can understand how to implement the technical solutions disclosed herein.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified or equivalently substituted for part of the technical features without departing from the scope and spirit of the present disclosure. The scope of the disclosure is defined by the following claims.

1. A display control method, comprising:
dividing a video frame received in a current frame period into m subframes, wherein the m subframes are in one-to-one correspondence with m display areas on a display device, m being a natural number greater than 1;
selecting a subframe from the m subframes as a target subframe according to a preset rule;
writing m−1 subframes other than the target subframe among the m subframes to a buffer;
reading m−1 subframes located between the target subframe of the current frame period and a target subframe of a previous frame period from the buffer according to a timing of each of the m subframes;
generating a display frame based on the target subframe of the current frame period and the m−1 subframes read from the buffer; and
sending the display frame to the display device for display.

2. The display control method according to claim 1, wherein the buffer comprises m−1 subbuffers that are in one-to-one correspondence with the m−1 subframes,
wherein the writing the m−1 subframes to the buffer comprises:
writing each of the m−1 subframes to a subbuffer corresponding to a current write address, wherein the current write address is determined from the current frame period.

3. The display control method according to claim 2, wherein the reading the m−1 subframes from the buffer comprises:
reading the m−1 subframes of the current frame period from the buffer in a case where the target subframe of the current frame period is a subframe with a latest timing of the current frame period.

4. The display control method according to claim 3, wherein the reading the m−1 subframes of the current frame period from the buffer comprises:
reading a subframe from each of the m−1 subbuffers according to a current read address, wherein the current read address is identical to the current write address.

5. The display control method according to claim 3, wherein the generating the display frame comprises:
combining the m−1 subframes of the current frame period and the target subframe of the current frame period to generate the display frame.

6. The display control method according to claim 2, wherein the reading the m−1 subframes from the buffer comprises:
reading last m−1 subframes in timing of the previous frame period from the buffer in a case where the target subframe of the current frame period is a subframe with an earliest timing of the current frame period.

7. The display control method according to claim 6, wherein the reading the m−1 subframes of the previous frame period from the buffer comprises:
reading a subframe from each of the m−1 subbuffers according to the current read address, wherein the current read address is the current write address subtracted by 1.

8. The display control method according to claim 6, wherein the generating the display frame comprises:
combining the target subframe of the current frame period and the last m−1 subframes in timing of the previous frame period to generate the display frame.

9. The display control method according to claim 2, wherein the reading the m−1 subframes from the buffer comprises:
reading k subframes of the current frame period from the buffer and reading last m−k−1 subframes in timing of the previous frame period from the buffer in a case where timings of the k subframes of the current frame period are earlier than a timing of the target subframe of the current frame period, wherein 1≤k<m−1.

10. The display control method according to claim 9, wherein:
the reading the k subframes from the buffer comprises:
reading the k subframes from k subbuffers corresponding to the k subframes among the m−1 subbuffers according to a first read address, wherein the first read address is identical to the current write address; and
the reading the m−k−1 subframes from the buffer comprises:
reading the m−k−1 subframes from m−k−1 subbuffers corresponding to the m−k−1 subframes among the m−1 subbuffers according to a second read address, wherein the second read address is the current write address subtracted by 1.

11. The display control method according to claim 9, wherein the generating the display frame comprises:
combining the k subframes of the current frame period, the target subframe of the current frame period and the m−k−1 subframes of the previous frame period to generate the display frame.

12. The display control method according to claim 1, wherein the target subframe is a subframe with a maximum delay weight among the m subframes, or is a subframe specified by a received instruction among the m subframes; and/or
wherein the sending the display frame to the display device comprises:
dividing the display frame into a first display subframe and a second display subframe;
sending the first display subframe to the display device through a first display interface; and
sending the second display subframe to the display device through a second display interface.

13. (canceled)

14. (canceled)

15. A display control apparatus, comprising:
a processor; and
a memory coupled to the processor, storing program instructions which, when executed by the processor, cause the processor to execute the display control method comprising:
dividing a video frame received in a current frame period into m subframes, wherein the m subframes are in one-to-one correspondence with m display areas on a display device, m being a natural number greater than 1;
selecting a subframe from the m subframes as a target subframe according to a preset rule;
writing m−1 subframes other than the target subframe among the m subframes to a buffer;
reading m−1 subframes located between the target subframe of the current frame period and a target subframe of a previous frame period from the buffer according to a timing of each of the m subframes;
generating a display frame based on the target subframe of the current frame period and the m−1 subframes read from the buffer; and
sending the display frame to the display device for display.

16. A display control apparatus, comprising:
a receiving circuit configured to receive a video frame of a current frame period;
a dividing circuit configured to divide the video frame of the current frame period into m subframes, wherein the m subframes are in one-to-one correspondence with m display areas on a display device, m being a natural number greater than 1;
a selecting circuit configured to select a subframe from the m subframes as a target subframe according to a preset rule, send the target subframe among the m subframes to a reordering circuit, and write m−1 subframes other than the target subframe among the m subframes to a buffer by a write control circuit;
the reordering circuit configured to read m−1 subframes located between the target subframe of the current frame period and a target subframe of a previous frame period from the buffer by a read control circuit according to a timing of each of the m subframes, and generate a display frame based on the target subframe of the current frame period and the m−1 subframes read from the buffer; and
a sending circuit configured to send the display frame to the display device for display.

17. The display control apparatus according to claim 16, wherein the buffer comprises m−1 subbuffers that are in one-to-one correspondence with the m−1 subframes,
wherein the write control circuit is configured to write each of the m−1 subframes to a subbuffer corresponding to a current write address, wherein the current write address is determined from the current frame period.

18. The display control apparatus according to claim 17, wherein
the reordering circuit is configured to read the m−1 subframes of the current frame period from the buffer by the read control circuit in a case where the target subframe of the current frame period is a subframe with a latest timing of the current frame period.

19. (canceled)

20. (canceled)

21. The display control apparatus according to claim 17, wherein
the reordering circuit is configured to read last m−1 subframes in timing of the previous frame period from the buffer by the read control circuit in a case where the target subframe of the current frame period is a subframe with an earliest timing of the current frame period.

22. (canceled)

23. (canceled)

24. The display control apparatus according to claim 17, wherein
the reordering circuit is configured to read k subframes of the current frame period from the buffer and read last m−k−1 subframes in timing of the previous frame period from the buffer by the read control circuit in a case where timings of the k subframes of the current frame period are earlier than a timing of the target subframe of the current frame period, wherein 1≤k<m−1.

25. (canceled)

26. (canceled)

27. A vehicle-mounted display system, comprising:
the display control apparatus according to 15; and
a display device configured to receive a display frame sent by the display control apparatus and present the display frame.

28. A non-transitory computer readable storage medium, wherein the computer readable storage medium stores computer instructions which, when executed by a processor, implement the display control method according to claim 1.
